(19) United States
(12) Patent Application Publication
(10) Pub. No.: US 2026/0310971 A1
(43) Pub. Date: Oct. 8, 2026

(54) DUAL-LOSS FRAMEWORK FOR ACCURATE BINDING AFFINITY PREDICTION IN BIOLOGICAL COMPLEXES

(71) Applicant: NVIDIA Corporation, Santa Clara, CA (US)

(72) Inventors: Meng LIU, San Jose, CA (US); Kit Sang CHU, Milpitas, CA (US); Farhad RAMEZANGHORBANI, Denver, CO (US); Saee PALIWAL, Brooklyn, NY (US)

(21) Appl. No.: 19/093,581

(22) Filed: Mar. 28, 2025

(51) Int. Cl. G06N 3/088

(52) U.S. Cl. CPC G06N 3/088

(57) ABSTRACT

In various examples, methods for training machine learning models to predict a binding affinity between molecules in a biological complex using supervised and unsupervised learning techniques includes generating an unlabeled training data set based on random perturbation applied to biological complexes included in a labeled training data set, wherein: the labeled training data set includes a plurality of samples of biological complexes, and each respective sample of a biological complex is associated with a calculated binding affinity between molecules in the respective sample; training a predictive model to predict binding affinity of a first molecule to a second molecule based on a first loss associated with the labeled training data set and a second loss associated with the unlabeled training data set; and deploying the trained predictive model.

### TECHNICAL FIELD

Embodiments of the present disclosure relate generally to binding affinity predictions for biological complexes, and more specifically to techniques for improving the accuracy of binding affinity predictions for biological complexes.

### BACKGROUND

In computational chemistry, various predictions may be used to predict binding affinities between different molecules, ions, or other molecular fragments (e.g., in a biological complex, such as a pairing of a protein and a ligand which may be a small molecule therapeutic, a large molecule therapeutic (e.g., a biologic product), another protein, etc.) without synthesizing molecules and testing the efficacy of synthesized molecules in a therapeutic complex. To predict the binding affinity between two molecules in a biological complex, predictions may be calculated for pairs of molecules from a library of molecules to generate a binding affinity prediction for the pair of molecules. The predicted binding affinity may subsequently be used to rank target molecules in a biological complex to determine which molecules are candidates for synthesis and testing for a therapeutic effect relative to the target molecule and which molecules are likely to not have a therapeutic effect relative to the target molecule. For example, molecules with high predicted binding affinities may be molecules with a strong bond in a biological complex (e.g., molecules that are ionically bonded, molecules that are bonded based on a large number of shared electrons in a covalent bond, etc.) and thus may be candidates for synthesis and testing. Meanwhile, molecules with low predicted binding affinities may have weak bonds in a biological complex (e.g., molecules that are bonded by hydrogen bonds, molecules bonded by van der Waals interaction, etc.) and thus may not be candidates for synthesis and testing.

Binding affinity predictions may thus be used in the process of developing therapeutics for various diseases by narrowing the search space of target molecules prior to synthesis and real-world testing of such target molecules. While these predictions may allow for the search space of target molecules to be narrowed, the accuracy of these predictions and thus the quality of the target molecules identified based on these predictions may depend on the model used to predict the binding affinity of molecules in a biological complex. Some models may be inaccurate because limited data exists to train such models, while other models may be inaccurate because the models themselves rely on unrealistic assumptions (e.g., that energy landscapes for different molecules follow the same energy distribution, such as a Boltzmann distribution in which the probability that a biological complex is in a given state is a function of the energy associated with the biological complex and a thermodynamic temperature of the biological complex).

As the foregoing illustrates, what is needed in the art are more effective techniques for predicting binding affinity between molecules in a biological complex.

### BRIEF DESCRIPTION OF DRAWINGS

FIG. 1 illustrates a block diagram of a computing system configured to implement one or more aspects of at least one embodiment;

FIG. 2 illustrates a training pipeline executed by the training engine of FIG. 1 to train a model for predicting binding affinity for molecules in a biological complex, according to at least one embodiment;

FIG. 3 illustrates example operations for training a model to predict binding affinity for molecules in a biological complex based on a supervised loss and an unsupervised loss;

FIG. 4 illustrates example operations for predicting binding affinity of molecules in a biological complex based on a machine learning model trained based on a supervised loss and an unsupervised loss;

FIG. 5A illustrates inference and/or training logic, according to at least one embodiment;

FIG. 5B illustrates inference and/or training logic, according to at least one embodiment; and

FIG. 6 illustrates training and deployment of a neural network, according to at least one embodiment.

### DETAILED DESCRIPTION

As discussed herein, identification of molecules for testing as potential treatments for various medical conditions is an important task in drug discovery. By identifying molecules for testing, the process of drug discovery may be accelerated, and resources may be dedicated to testing molecules that are more likely to have a therapeutic effect than those that are less likely to have a therapeutic effect or are likely to have no therapeutic effect at all. As discussed above, however, predictions of binding affinity, which correlate to the likelihood of a molecule having a therapeutic effect, may be inaccurate due to limitations of models used to predict the binding affinity of molecules in a biological complex.

In some cases, a model used to predict the binding affinity of molecules in a biological complex may be trained using supervised learning techniques in which a biological complex (e.g., a protein-ligand pair) is labeled with a measured, observed, or estimated binding affinity (e.g., measured in calories/mol). Because the training data sets used to train models using supervised learning techniques may be relatively sparse, models trained using supervised learning techniques may not be able to generalize across diverse biological complexes having different structures than those included in the training data sets.

In some cases, to compensate for the relative sparsity of labeled data, energy-based models can be used to estimate the binding affinity of molecules in a biological complex. These energy-based models may assign a scalar energy value to different configurations of biological complexes and may be trained, for example, using a denoising score matching objective that learns an energy function from a set of biological complexes. Specifically, in the context of binding affinities in biological complexes, models trained using unsupervised learning techniques may assume that the distribution of training samples aligns with a Boltzmann distribution. This assumption generally implies that the probability p(C) of a biological complex C being observed is proportion to exp(−E(C)), where E(C) represents a binding energy between molecules in a biological complex and where lower binding energies indicate stronger interactions between molecules in a biological complex. Generally, these models can leverage significantly larger training data sets than those used in training models using supervised learning techniques; however, the assumption that the training data follows a Boltzmann distribution may be inaccurate, and the model may be limited to predicting relative (comparative) binding affinities instead of absolute binding affinity predictions.

To compensate for the sparsity of data in labeled training data sets used to train binding affinity prediction models using supervised learning techniques and the inaccuracy and predictive limitations of models trained using unsupervised learning techniques, embodiments described herein use a dual-loss framework to allow the model to more accurately predict binding affinities and allow for predictions of molecule binding affinity that generalizes across a variety of biological complexes. In training a model using a dual-loss framework, two loss functions are calculated: [symbol] _{MSE} calculated for labeled data, and [symbol] _{M} calculated for the unlabeled data generated based on the perturbation of molecule structure in a labeled data set based on Gaussian noise or other appropriate noise. The perturbation of a molecule structure may be, in some embodiments, constrained by a maximum displacement that can be applied to a molecule structure such that the perturbed molecule structure is still a chemically valid structure (e.g., such that bond distances remain valid, etc.). [symbol] _{DSM} generally allows for the energy landscape to be shaped such that valleys in the energy landscape align with the unperturbed molecule structures.

One technical advantage of the disclosed techniques relative to prior approaches is increased generality and prediction accuracy for the binding affinity of molecules in a biological complex. By training a model using supervised learning techniques and unsupervised learning techniques, limitations on model accuracy from sparse labeled data sets may be overcome, as the risk of the model being overfit to the training data may be reduced. Further, limitations on predictive accuracy imposed by inaccurate assumptions related to the distribution of training data in an unlabeled data set may also be overcome, and the model can generate a predicted affinity value instead of a comparative value that models trained using unsupervised learning techniques generate.

The above examples are not in any way intended to be limiting. As persons skilled in the art will appreciate, as a general matter, the techniques for automatically generating dialogue flows from unlabeled conversation data can be implemented in any suitable application.

The systems and methods described herein may be used for a variety of purposes, by way of example and without limitation, for use in systems associated with machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an infotainment or plug-in gaming/streaming system of an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs), small language models (SLMs), vision language models (VLMs), and/or multi-modal language models (MMLMs) that may process text, audio, and/or image data, systems for performing light transport simulation, systems for performing collaborative content creation for 3D assets (e.g., systems or platforms that use universal scene descriptor (USD) data, such as OpenUSD), systems implemented at least partially using cloud computing resources, systems for performing generative AI operations, and/or other types of systems.

### System Overview

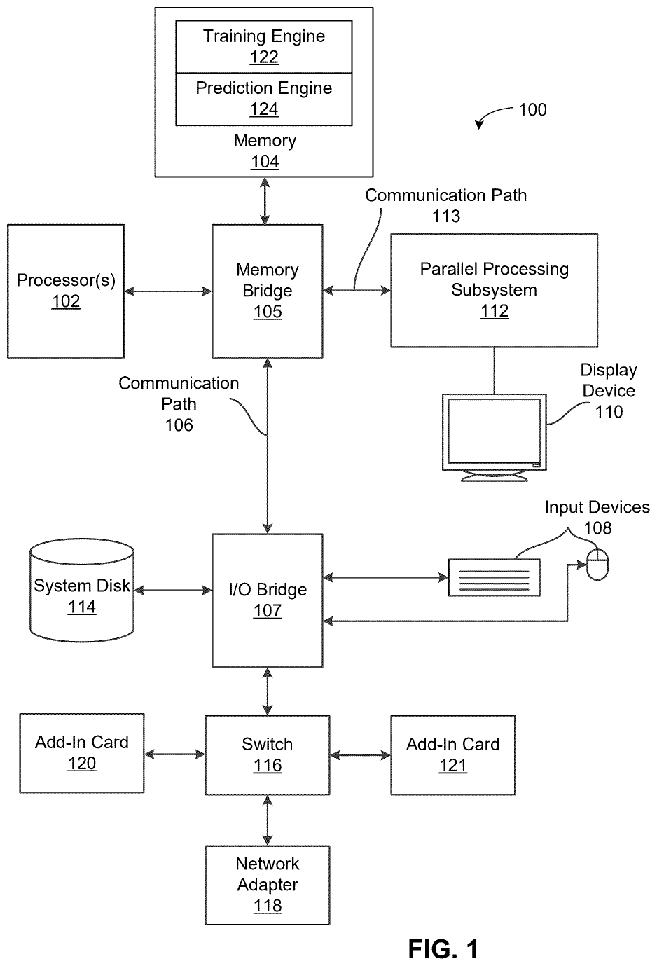

FIG. 1 is a block diagram illustrating a computing system 100 configured to implement one or more aspects of at least one embodiment. In at least one embodiment, computing system 100 may include any type of computing device, including, without limitation, a server machine, a server platform, a desktop machine, a laptop machine, a hand-held/mobile device, a digital kiosk, an in-vehicle infotainment system, a smart speaker or display, a television, and/or a wearable device. In at least one embodiment, computing system 100 is a server machine operating in a data center or a cloud computing environment that provides scalable computing resources as a service over a network.

In various embodiments, computing system 100 includes, without limitation, one or more processors 102 and one or more memories 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as (but not limited to) a keyboard, mouse, touch screen, sensor data analysis (e.g., evaluating gestures, speech, or other information about one or more uses in a field of view or sensory field of one or more sensors), a VR/MR/AR headset, a gesture recognition system, a steering wheel, mechanical, digital, or touch sensitive buttons or input components, and/or a microphone, and forward the input information to processor(s) 102 for processing. In at least one embodiment, computing system 100 may be a server machine in a cloud computing environment. In such embodiments, computing system 100 may omit input devices 108 and receive equivalent input information as commands (e.g., responsive to one or more inputs from a remote computing device) and/or messages transmitted over a network and received via the network adapter 118. In at least one embodiment, switch 116 is configured to provide connections between I/O bridge 107 and other components of computing system 100, such as a network adapter 118 and various add-in cards 120 and 121.

In at least one embodiment, I/O bridge 107 is coupled to a system disk 114 that may be configured to store content and applications and data for use by processor(s) 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computing system 100, may be implemented using any technically suitable protocols, including, without limitation, AGP (Accelerated Graphics Port), HyperTransport, or any other bus or point-to-point communication protocol known in the art.

In at least one embodiment, parallel processing subsystem 112 includes a graphics subsystem that delivers pixels to an optional display device 110 that may be any conventional cathode ray tube, liquid crystal display, light-emitting diode display, and/or the like. In such embodiments, parallel processing subsystem 112 may incorporate circuitry optimized for graphics and video processing, including, for example, video output circuitry. Such circuitry may be incorporated across one or more parallel processing units (PPUs), also referred to herein as parallel processors, included within the parallel processing subsystem 112.

In at least one embodiment, parallel processing subsystem 112 incorporates circuitry optimized (e.g., that undergoes optimization) for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and/or compute processing operations. Memor(ies) 104 include at least one device driver configured to manage the processing operations of the one or more PPUs within parallel processing subsystem 112. In addition, memor(ies) 104 include instructions implementing a training engine 122 and a prediction engine 124, which can be executed by processor(s) and/or parallel processing subsystem 112.

In various embodiments, parallel processing subsystem 112 may be integrated with one or more of the other elements of FIG. 1 to form a single system. For example, parallel processing subsystem 112 may be integrated with processor(s) 102 and other connection circuitry on a single chip to form a system on a chip (SoC).

Processor(s) 102 may include any suitable processor implemented as a central processing unit (CPU), a graphics processing unit (GPU), an application-specific integrated circuit (ASIC), a field programmable gate array (FPGA), an artificial intelligence (AI) accelerator, a deep learning accelerator (DLA), a parallel processing unit (PPU), a data processing unit (DPU), a vector or vision processing unit (VPU), a programmable vision accelerator (PVA) (which may include one or more VPUs, pixel processing engines (PPEs), and/or direct memory access (DMA) systems), any other type of processing unit, or a combination of different processing units, such as a CPU(s) configured to operate in conjunction with a GPU(s). In general, processor(s) 102 may include any technically feasible hardware unit capable of processing data and/or executing software applications. Further, in the context of this disclosure, the computing elements shown in computing system 100 may correspond to a physical computing system (e.g., a system in a data center or a machine) and/or may correspond to a virtual computing instance executing within a computing cloud.

In at least one embodiment, processor(s) 102 issue commands that control the operation of PPUs. In at least one embodiment, communication path 113 is a Peripheral Component Interconnect Express (PCIe) link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processors 102, and the number of parallel processing subsystems 112, may be modified as desired. For example, in at least one embodiment, memor(ies) 104 may be connected to processor(s) 102 directly rather than through memory bridge 105, and other devices may communicate with memor(ies) 104 via memory bridge 105 and processors 102. In other embodiments, parallel processing subsystem 112 may be connected to I/O bridge 107 or directly to processor(s) 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 may be eliminated, and network adapter 118 and add-in cards 120, 121 would connect directly to I/O bridge 107. Further, in certain embodiments, one or more components shown in FIG. 1 may be implemented as virtualized resources in a virtual computing environment, such as a cloud computing environment. In particular, the parallel processing subsystem 112 may be implemented as a virtualized parallel processing subsystem in at least one embodiment. For example, the parallel processing subsystem 112 may be implemented as a virtual graphics processing unit(s) (vGPU(s)) that renders graphics on a virtual machine(s) (VM(s)) executing on a server machine(s) whose GPU(s) and other physical resources are shared across one or more VMs.

In some embodiments, training engine 122 and a prediction engine 124 include functionality to train and use machine learning models to predict binding affinities for molecules in a biological complex. As discussed in further detail herein, a machine learning model for predicting binding affinities for molecules in a biological complex may be trained using a dual-loss framework. The dual-loss framework generally trains the model using a first loss associated with labeled training data and a second loss associated with unlabeled training data. Generally, the unlabeled training data may be generated by the training engine 122 by applying various perturbations to the biological complexes in the labeled training data (e.g., random noise to the positions of atoms in a molecule in a biological complex). By doing so, as discussed, embodiments presented herein may train and use models that have higher prediction accuracy than models trained using supervised learning techniques or unsupervised learning techniques in isolation.

### Dual-Loss Framework for Training Machine Learning Models to Predict Binding Affinity Between Molecules in a Biological Complex

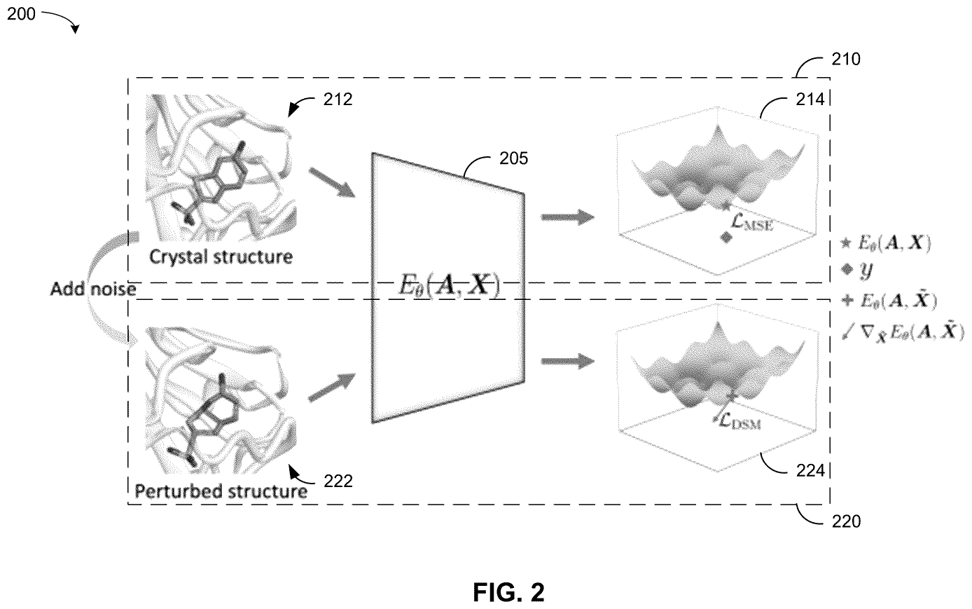

FIG. 2 illustrates a training pipeline 200 for training a model for predicting binding affinity for molecules in a biological complex, according to at least one embodiment. In some embodiments, the training pipeline 200 may be executed by the training engine 122 illustrated in FIG. 1.

To train a machine learning model to predict a binding affinity between molecules in a biological complex, the training pipeline 200 may generate the model using a first loss in a supervised training pipeline 210 and a second loss in an unsupervised training pipeline 220. Generally, a labeled training data set, including one or more biological complexes 212 labeled with an observed or estimated binding affinity may be used to generate an unsupervised training data set including one or more perturbed biological complexes 222 used, as discussed in further detail below, in the unsupervised training pipeline 220. A biological complex 212 or a perturbed biological complex 222, which may be a protein-ligand complex, may be represented as a structure C=(A, X), where A∈ [symbol] represents the n atoms in the biological complex including a first molecule (e.g., a protein) and a second molecule (e.g., a ligand, which, as discussed, may be a small molecule therapeutic, a large molecule therapeutic, another protein, etc.). X∈ [symbol] represents the coordinates of the atoms A in the complex C. The binding affinity model 205 may be represented by the expression E_{θ}(A, X): [symbol] × [symbol] → [symbol] and may result in a scalar energy value for any given biological complex C. θ generally represents the learnable parameters of the binding affinity model 205.

Within the supervised training pipeline 210, a labeled training data set including biologic complexes (e.g., biological complex 212) and a ground-truth (estimated or observed) binding affinity may be used to train a model based on a supervised learning loss, such as a mean squared error loss [symbol] _{MSE}. The mean squared error loss [symbol] _{MSE} may represent an error computed between a predicted binding affinity generated by the binding affinity model 205 and the ground-truth binding affinity associated with a biological complex 212. Formally, [symbol] _{MSE} may be represented by the equation:

$${ℒ}_{MSE} = {( {E}_{θ} ( A , X ) - y )}^{2}$$

where y represents the ground-truth binding affinity associated with a biological complex 212 (A, X). As illustrated in the supervised loss graph 214, the distance between E_{θ}(A, X) and y for the biological complex 212 may be the basis on which [symbol] _{MSE} is calculated. Backpropagating [symbol] _{MSE} through the binding affinity model 205 may allow the binding affinity model 205 to align predictions of binding affinities to ground-truth binding affinities. In doing so, points representing observed crystal structures within an energy landscape may be anchored to the ground-truth binding affinities.

As discussed, because labeled training data sets used in the supervised training pipeline 210 may be relatively sparse, embodiments presented herein additionally use an unlabeled training data set to train the binding affinity model 205. To generate the unlabeled training data set, biological complexes 212 in the labeled training data set may be perturbed (e.g., using Gaussian noise or the like). These perturbations may, in some embodiments, change the structure of a biological complex or a molecule therein (e.g., a ligand in a protein-ligand complex) by adjusting the location in three-dimensional (Euclidean) space of one or more atoms in the molecule. The adjustment to the location of atoms in a molecule may thus modify bond distances between different atoms in a molecule. For a given molecule or other crystal structure (A, X) with each molecule having a three-dimensional coordinate xᵢ∈X, a perturbed coordinate x̅ᵢ may be obtained according to the equation:

$${\overline{x}}_{i} = {x}_{i} + {σϵ}_{i}$$

where ∈ᵢ~ [symbol] (0, I₃) and σ is a hyperparameter that tunes the amount of noise added to molecule coordinates in the Euclidean space.

The resulting perturbed biological complex, including an unperturbed first molecule (e.g., a protein in a protein-ligand structure) and a perturbed second molecule (e.g., a ligand in a protein-ligand structure) having coordinates X̅ may be input into the binding affinity model 205 to generate a predicted energy E_{θ}(A, X̅). A denoising score matching (DSM) loss, [symbol] _{MSE} may be calculated by matching the score of a model distribution p_{θ} at the perturbed data X̅ with the score of a distribution q from which X̅ is sampled. The score of the model distribution p_{θ} may be defined as the gradient of the log-probability with respect to X̅, and the corresponding DSM loss may be represented by the equation:

$${ℒ}_{DSM} = {\text{?}}_{q ( \overline{X} )} [ {‖ {∇}_{\overline{X}} log {p}_{θ} ( A , \overline{X} ) - {∇}_{\overline{X}} log q ( \overline{X} ) ‖}^{2} ]$$

The above equation may be equivalent to:

$${ℒ}_{DSM} = {\text{?}}_{q ( \overline{X} \vert X ) {p}_{data} ( X )} [ {‖ {∇}_{\overline{X}} log {p}_{θ} ( A , \overline{X} ) - {∇}_{\overline{X}} log q ( \overline{X} \vert X ) ‖}^{2} ]$$

The distribution given by the output E_{θ}(A, X̅) generated by the binding affinity model 205 may be defined according to the equation:

$${p}_{θ} = \frac{exp ( - {E}_{θ} ( A , \overline{X} )}{{Z}_{θ}}$$

where Z_{θ} is a normalizing constant that may be intractable but constant with respect to X̅. Based on the normalizing constant being a constant with respect to X̅, ∇_{X̅} log p_{θ}(A, X̅) may be computed according to the equation:

$${∇}_{\overline{X}} log {p}_{θ} ( A , \overline{X} ) = - {∇}_{\overline{X}} {E}_{θ} ( A , \overline{X} ) - {∇}_{\overline{X}} log {Z}_{θ} = - {∇}_{\overline{X}} {E}_{θ} ( A , \overline{X} )$$

Similarly, ∇_{X̅} log q(X̅|X) may be computed as

$${∇}_{\overline{X}} log q ( \overline{X} \vert X ) = \frac{\overline{X} - X}{{σ}^{2}} ,$$

as q(X̅|X) may be a Gaussian distribution. Thus, the DSM loss [symbol] _{DSM}, illustrated by the gradient from E_{θ}(A, X̅) in the graph 224, may be represented by the simplified equation:

$${ℒ}_{DSM} = {\text{?}}_{q ( \overline{X} \vert X ) {p}_{data} ( X )} [ {‖ - {∇}_{\overline{X}} {E}_{θ} ( A , \overline{X} ) - \frac{\overline{X} - X}{{σ}^{2}} ‖}^{2} ]$$

The DSM loss [symbol] _{DSM} may be backpropagated through the binding affinity model 205 to train the model. By using [symbol] _{DSM} to train the binding affinity model 205, the model may learn to shape an energy landscape such that local minima or other energy valleys align with the original unperturbed biological complex structures.

Generally, [symbol] _{MSE} and [symbol] _{DSM} may be used in conjunction to train the binding affinity model 205. A total loss for training the binding affinity model 205 may be calculated as [symbol] = [symbol] _{MSE}+λ [symbol] _{DSM}, where λ corresponds to a hyperparameter that balances the influence of the supervised learning loss and the unsupervised learning loss in training the binding affinity model 205.

In some embodiments, using [symbol] _{MSE} and [symbol] _{DSM} in conjunction to train the binding affinity model 205 may allow for the binding affinity model 205 to be dynamically adjusted during training. For example, during training, λ may be adjusted so that a specific type of loss (e.g., [symbol] _{MSE} or [symbol] _{DSM}) does not dominate the total loss [symbol] used in training the binding affinity model. By doing so, embodiments presented herein may prevent a scenario in which the binding affinity model 205 converges on a training objective for one training pipeline (e.g., the supervised training pipeline 210 (associated with [symbol] _{MSE}) or the unsupervised training pipeline 220 (associated with [symbol] _{DSM})) before the other training pipeline reaches its learning potential. In such a case, [symbol] may be defined according to the equation:

$$ℒ = ( \frac{1}{2} {σ}_{{MSE}^{2}} ) {ℒ}_{MSE} + ( \frac{1}{2} {σ}_{{DSM}^{2}} ) {ℒ}_{DSM}$$

In the equation above, σ_{MSE}² and σ_{DSM}² may be learned parameters that represent task-specific prediction uncertainties. Minimizing the total loss [symbol] with respect to σ_{MSE} and σ_{DSM} may be equivalent to adaptively adjusting the relative weights of the supervised loss and the unsupervised loss based on the data.

While FIG. 2 illustrates techniques for training the binding affinity model 205 using a labeled training data set and unlabeled training data derived from the labeled training data set, it should be recognized that the binding affinity model 205 may be further trained and/or refined based on unlabeled training data sets. Where an unlabeled training data set not derived from a labeled training data set is used to train and/or refine the binding affinity model 205, execution of the supervised training pipeline 210 may be omitted, and a DSM loss may be used to train the model. In some embodiments, the use of additional unlabeled training data sets beyond those derived from a labeled training data set to train the binding affinity model 205 may allow for increased inferencing performance over models trained using supervised learning techniques and the labeled training data set.

In some embodiments, the binding affinity model 205 may be a three-dimensional attention model that is equivariant to three-dimensional rotations and translations. The binding affinity model may be built on a frame averaging neural network that allows for atom representations to be generated for the different atoms in a biological complex. Energy predictions may be made by the binding affinity model 205 by considering pairwise atomic interactions within a defined distance threshold. Generally, the defined distance threshold may correlate to distance thresholds for different types of molecular bonds. For example, the distance threshold may allow for the calculation of atomic interactions for atoms that are within a maximum distance over which a weak attractive force, such as a van der Waals interaction, can potentially bind atoms together. In another example, the distance threshold may allow for the calculation of atomic interactions for atoms that are within a maximum distance over which a strong attractive force, such as a proton-electron bond in a covalent or ionic bond, can potentially bind atoms together.

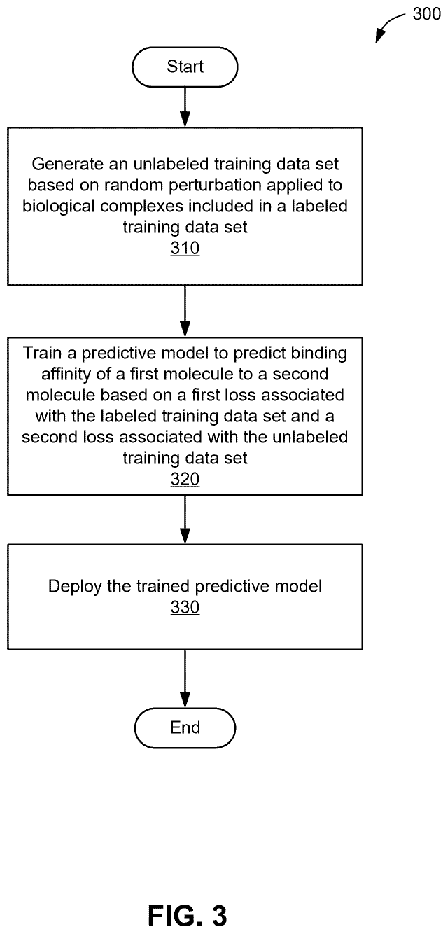

FIG. 3 illustrates example operations 300 for training a model to predict binding affinity for molecules in a biological complex based on a supervised loss and an unsupervised loss. The operations 300 may be performed, for example, by a computing device on which a machine learning model can be trained, such as a computing device on which training engine 122 illustrated in FIG. 1 executes. The computing device may be a cloud computing instance, a physical cluster of computers, a server, or the like.

As illustrated, operations 300 begin at block 310 with generating an unlabeled training data set based on random perturbation applied to biological complexes included in a labeled training data set. Generally, the labeled training data set may include a plurality of samples of biological complexes. Each respective sample of a biological complex in the labeled training data set is associated with a calculated binding affinity between molecules in the respective sample.

In some embodiments, a biological complex may include a first molecule and a second molecule. The first molecule may be, for example, a protein in a biological complex, and the second molecule may be a ligand in the biological complex. It should be understood that a ligand may be any type of molecule that can bind to a protein in the biological complex and have a potential therapeutic effect caused by binding to the protein in the biological complex. The ligand may be a small molecule therapeutic (e.g., an organic compound having a size such that the compound can pass through cell membranes to reach and bind to an intracellular target), a large molecule therapeutic (e.g., a biologic product), a protein, an antibody, or other type of molecule that can have a therapeutic effect.

In some embodiments, to generate the unlabeled training data set, the training engine can generate a perturbed biological complex from a base biological complex. The generation of the perturbed biological complex may be based on applying a scaled amount of noise to one or more coordinates in the base biological complex. In some embodiments, the perturbed biological complex may include an unperturbed first molecule from the base biological complex and a perturbed version of a second molecule from the base biological complex. That is, in an example in which the biological complex is a protein-ligand pair, the protein may remain unperturbed, while the ligand may be modified based on an amount of noise sampled from a Gaussian distribution and scaled according to a noise scaling parameter that may be learned or defined a priori for the model.

At block 320, operations 300 proceed with training a predictive model (e.g., the binding affinity model 205 illustrated in FIG. 2 and discussed above) to predict binding affinity of a first molecule to a second molecule based on a first loss associated with the labeled training data set and a second loss associated with the unlabeled training data set.

In some embodiments, the first loss associated with the labeled training data set comprises a mean-squared error loss between a predicted binding affinity between molecules in a biological complex in the labeled training data set and a calculated binding affinity for the biological complex in the labeled training data set. The second loss associated with the unlabeled training data set may be a denoising loss between a perturbed biological complex in the unlabeled training data set and a base biological complex in the labeled training data set.

In some embodiments, the denoising loss may be a difference between a probability distribution associated with a predicted energy for the perturbed biological complex and a probability distribution associated with a predicted energy for the base biological complex from which the perturbed biological complex is sampled. The denoising loss may, in some embodiments, comprise a difference between a probability distribution associated with a predicted energy for the perturbed biological complex and a probability distribution associated with a predicted energy for the base biological complex from which the perturbed biological complex is sampled.

In some embodiments, the predictive model may be trained further based on a weighting factor applied to the second loss. The weighting factor may represent a hyperparameter that balances the influence of the first loss (e.g., the supervised training loss) and the second loss (e.g., the unsupervised training loss) in training the predictive model. In some embodiments, the weighting factor may be a weight applied to one of the loss values (e.g., λ applied to the unsupervised training loss). In some embodiments, the weighting factor may include a weight associated with the supervised training loss (σ_{MSE}) and a weight associated with the unsupervised training loss (σ_{DSM}), which may allow for the weighting applied to the first loss and the second loss to be dynamically adjusted during training.

At block 330, operations 300 proceed with deploying the trained predictive model.

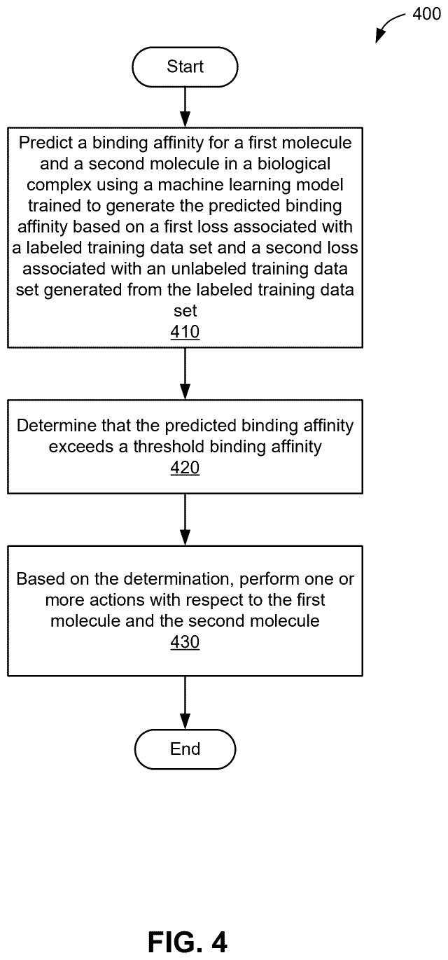

FIG. 4 illustrates example operations 400 for predicting binding affinity of molecules in a biological complex based on a machine learning model trained based on a supervised loss and an unsupervised loss. The operations 400 may be performed, for example, by a computing device, such as a desktop computer, a laptop computer, a server, a cloud computing instance, or the like, on which a prediction engine, such as prediction engine 124 illustrated in FIG. 1, executes.

As illustrated, the operations 400 begin at block 410 with predicting a binding affinity for a first molecule and a second molecule in a biological complex using a machine learning model. Generally, the machine learning model may be a predictive model (e.g., the binding affinity model 205 illustrated in FIG. 2 and described above) trained to generate the predicted binding affinity based on a first loss associated with a labeled training data set and a second loss associated with an unlabeled training data set generated from the labeled training data set. In some embodiments, the first loss associated with the labeled training data set comprises a mean-squared error loss between a predicted binding affinity between molecules in a biological complex in the labeled training data set and a calculated binding affinity for the biological complex in the labeled training data set. The second loss associated with the unlabeled training data set may be a denoising loss between a perturbed biological complex in the unlabeled training data set and a base biological complex in the labeled training data set.

At block 420, the operations 400 proceed with determining that the predicted binding affinity for the first molecule and the second molecule in the biological complex exceeds a threshold binding affinity.

At block 430, the operations 400 proceed with performing, based on the determining, one or more actions with respect to the first molecule and the second molecule.

In some embodiments, the first molecule and the second molecule may be molecules in a biological complex. The first molecule may be, for example, a protein in a biological complex, and the second molecule may be a ligand in the biological complex. It should be understood that a ligand may be any type of molecule that can bind to a protein in the biological complex and have a potential therapeutic effect caused by binding to the protein in the biological complex. The ligand may be a small molecule therapeutic (e.g., an organic compound having a size such that the compound can pass through cell membranes to reach and bind to an intracellular target), a large molecule therapeutic (e.g., a biologic product), a protein, an antibody, or other type of molecule that can have a therapeutic effect.

In some embodiments, the one or more actions comprise synthesizing the second molecule in the biological complex as a treatment for a medical condition.

By training a predictive model based on supervised and unsupervised learning techniques to predict the binding affinity of molecules in a biological complex, embodiments presented herein generally allow for increased predictive performance relative to models trained using solely supervised learning techniques or unsupervised learning techniques. Further, unlike models trained using unsupervised learning techniques in which the output is a relative or comparative binding affinity prediction (e.g., an indication that one molecule has a higher binding affinity than another molecule), the predictive models described herein may output an absolute binding affinity prediction. Because the predictive models described herein can generate absolute binding affinity predictions, the predictive models may allow for improved efficiency and reduced computational resource expenditure in identifying molecules that are potential therapeutics for a given disease or condition. Finally, by using both supervised and unsupervised learning techniques to train a predictive model, embodiments presented herein may allow a predictive model to generalize and generate accurate binding affinity predictions for a wide variety of molecules instead of molecules that are similar to those included in a labeled training data set used to train a model using supervised learning techniques.

### Inference and Training Logic

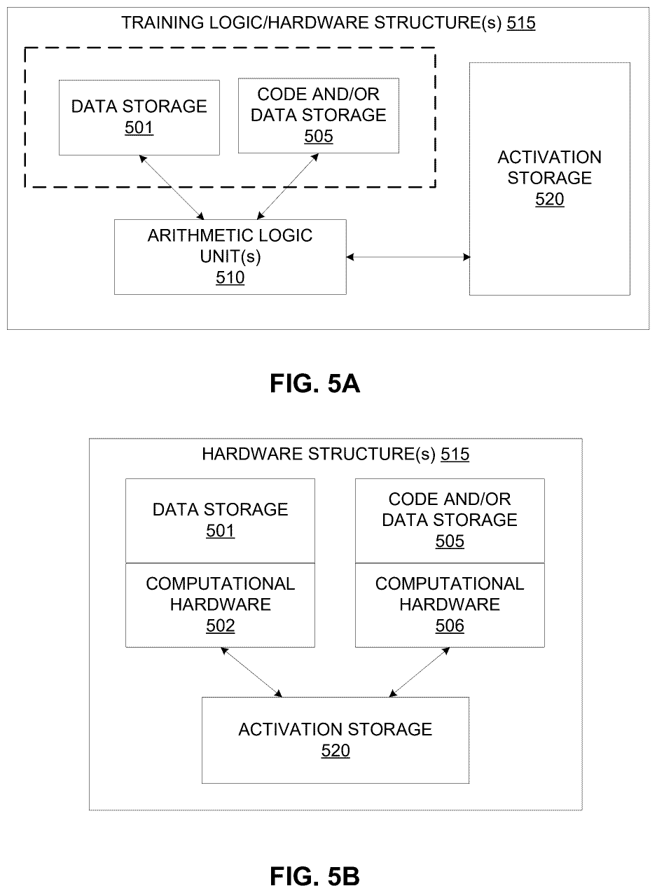

FIG. 5A illustrates inference and/or training logic 515 used to perform inferencing and/or training operations associated with one or more embodiments. Details regarding inference and/or training logic 515 are provided herein in conjunction with at least FIGS. 5A and/or 5B.

In at least one embodiment, inference and/or training logic 515 may include, without limitation, code and/or data storage 501 to store forward and/or output weight and/or input/output data, and/or other parameters to configure neurons or layers of a neural network trained and/or used for inferencing in aspects of one or more embodiments. In at least one embodiment, training logic 515 may include, or be coupled to code and/or data storage 501 to store graph code or other software to control timing and/or order, in which weight and/or other parameter information is to be loaded to configure, logic, including integer and/or floating point units (collectively, arithmetic logic units (ALUs)). In at least one embodiment, code, such as graph code, loads weight or other parameter information into processor ALUs based on an architecture of a neural network to which such code corresponds. In at least one embodiment, code and/or data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 501 may be included with other on-chip or off-chip data storage, including a processor's L1, L2, or L3 cache or system memory.

In at least one embodiment, any portion of code and/or data storage 501 may be internal or external to one or more processors or other hardware logic devices or circuits. In at least one embodiment, code and/or code and/or data storage 501 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 501 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a code and/or data storage 505 to store backward and/or output weight and/or input/output data corresponding to neurons or layers of a neural network trained and/or used for inferencing in aspects of one or more embodiments. In at least one embodiment, code and/or data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 515 may include, or be coupled to code and/or data storage 505 to store graph code or other software to control timing and/or order, in which weight and/or other parameter information is to be loaded to configure, logic, including integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 505 may be included with other on-chip or off-chip data storage, including a processor's L1, L2, or L3 cache or system memory. In at least one embodiment, any portion of code and/or data storage 505 may be internal or external to one or more processors or other hardware logic devices or circuits. In at least one embodiment, code and/or data storage 505 may be cache memory, DRAM, SRAM, non-volatile memory (e.g., flash memory), or other storage. In at least one embodiment, a choice of whether code and/or data storage 505 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 501 and code and/or data storage 505 may be separate storage structures. In at least one embodiment, code and/or data storage 501 and code and/or data storage 505 may be a combined storage structure. In at least one embodiment, code and/or data storage 501 and code and/or data storage 505 may be partially combined and partially separate. In at least one embodiment, any portion of code and/or data storage 501 and code and/or data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 520 that are functions of input/output and/or weight parameter data stored in code and/or data storage 501 and/or code and/or data storage 505. In at least one embodiment, activations stored in activation storage 520 are generated according to linear algebraic and or matrix-based mathematics performed by ALU(s) 510 in response to performing instructions or other code, wherein weight values stored in code and/or data storage 505 and/or data storage 501 are used as operands along with other values, such as bias values, gradient information, momentum values, or other parameters or hyperparameters, any or all of which may be stored in code and/or data storage 505 or code and/or data storage 501 or another storage on or off-chip.

In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALUs 510 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 501, code and/or data storage 505, and activation storage 520 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., flash memory), or other storage. In at least one embodiment, activation storage 520 may be completely or partially within or external to one or more processors or other logical circuits. In at least one embodiment, a choice of whether activation storage 520 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 illustrated in FIG. 5A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, code and/or data storage 501 and code and/or data storage 505, which may be used to store code (e.g., graph code), weight values and/or other information, including bias values, gradient information, momentum values, and/or other parameter or hyperparameter information. In at least one embodiment illustrated in FIG. 5B, each of code and/or data storage 501 and code and/or data storage 505 is associated with a dedicated computational resource, such as computational hardware 502 and computational hardware 506, respectively. In at least one embodiment, each of computational hardware 502 and computational hardware 506 comprises one or more ALUs that perform mathematical functions, such as linear algebraic functions, only on information stored in code and/or data storage 501 and code and/or data storage 505, respectively, result of which is stored in activation storage 520.

In at least one embodiment, each of code and/or data storage 501 and 505 and corresponding computational hardware 502 and 506, respectively, correspond to different layers of a neural network, such that resulting activation from one storage/computational pair 501/502 of code and/or data storage 501 and computational hardware 502 is provided as an input to a next storage/computational pair 505/506 of code and/or data storage 505 and computational hardware 506, in order to mirror a conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage/computation pairs 501/502 and 505/506 may be included in inference and/or training logic 515.

### Neural Network Training and Deployment

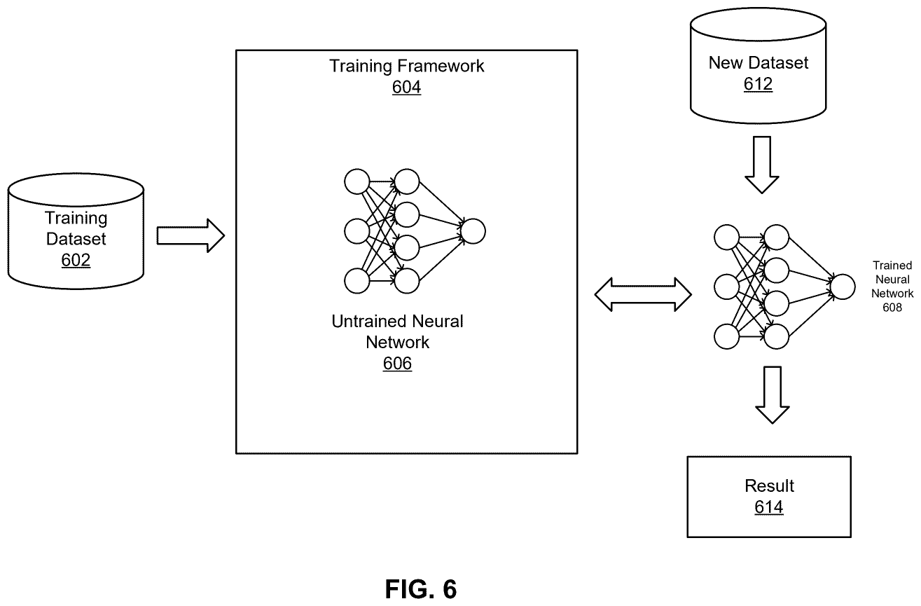

FIG. 6 illustrates training and deployment of a deep neural network, according to at least one embodiment. In at least one embodiment, untrained neural network 606 is trained using a training dataset 602. In at least one embodiment, training framework 604 is a PyTorch framework, whereas in other embodiments, training framework 604 is a TensorFlow, Boost, Caffe, Microsoft Cognitive Toolkit/CNTK, MXNet, Chainer, Keras, Deeplearning4j, or other training framework. In at least one embodiment, training framework 604 trains an untrained neural network 606 and enables it to be trained using processing resources described herein to generate a trained neural network 608. In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having a known output and an output of neural network 606 is manually graded. In at least one embodiment, untrained neural network 606 is trained in a supervised manner and processes inputs from training dataset 602 and compares resulting outputs against a set of expected or desired outputs. In at least one embodiment, errors are then propagated back through untrained neural network 606. In at least one embodiment, training framework 604 adjusts weights that control untrained neural network 606. In at least one embodiment, training framework 604 includes tools to monitor how well untrained neural network 606 is converging towards a model, such as trained neural network 608, suitable to generating correct answers, such as in result 614, based on input data such as a new dataset 612. In at least one embodiment, training framework 604 trains untrained neural network 606 repeatedly while adjust weights to refine an output of untrained neural network 606 using a loss function and adjustment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, wherein untrained neural network 606 attempts to train itself using unlabeled data. In at least one embodiment, unsupervised learning training dataset 602 will include input data without any associated output data or “ground truth” data. In at least one embodiment, untrained neural network 606 can learn groupings within training dataset 602 and can determine how individual inputs are related to untrained dataset 602. In at least one embodiment, unsupervised training can be used to generate a self-organizing map in trained neural network 608 capable of performing operations useful in reducing dimensionality of new dataset 612. In at least one embodiment, unsupervised training can also be used to perform anomaly detection, which allows identification of data points in new dataset 612 that deviate from normal patterns of new dataset 612.

In at least one embodiment, semi-supervised learning may be used, which is a technique in which in training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new dataset 612 without forgetting knowledge instilled within trained neural network 608 during initial training.

In at least one embodiment, training framework 604 is a framework processed in connection with a software development toolkit such as an OpenVINO (Open Visual Inference and Neural network Optimization) toolkit. In at least one embodiment, an OpenVINO toolkit is a toolkit such as those developed by Intel Corporation of Santa Clara, CA.

In at least one embodiment, OpenVINO is a toolkit for facilitating development of applications, specifically neural network applications, for various tasks and operations, such as human vision emulation, speech recognition, natural language processing, recommendation systems, and/or variations thereof. In at least one embodiment, OpenVINO supports neural networks such as convolutional neural networks (CNNs), recurrent and/or attention-based neural networks, and/or various other neural network models. In at least one embodiment, OpenVINO supports various software libraries such as OpenCV, OpenCL, and/or variations thereof.

In at least one embodiment, OpenVINO supports neural network models for various tasks and operations, such as classification, segmentation, object detection, face recognition, speech recognition, pose estimation (e.g., humans and/or objects), monocular depth estimation, image inpainting, style transfer, action recognition, colorization, and/or variations thereof.

In at least one embodiment, OpenVINO comprises one or more software tools and/or modules for model optimization, also referred to as a model optimizer. In at least one embodiment, a model optimizer is a command line tool that facilitates transitions between training and deployment of neural network models. In at least one embodiment, a model optimizer optimizes neural network models for execution on various devices and/or processing units, such as a GPU, CPU, PPU, GPGPU, and/or variations thereof. In at least one embodiment, a model optimizer generates an internal representation of a model, and optimizes said model to generate an intermediate representation. In at least one embodiment, a model optimizer reduces a number of layers of a model. In at least one embodiment, a model optimizer removes layers of a model that are utilized for training. In at least one embodiment, a model optimizer performs various neural network operations, such as modifying inputs to a model (e.g., resizing inputs to a model), modifying a size of inputs of a model (e.g., modifying a batch size of a model), modifying a model structure (e.g., modifying layers of a model), normalization, standardization, quantization (e.g., converting weights of a model from a first representation, such as floating point, to a second representation, such as integer), and/or variations thereof.

In at least one embodiment, OpenVINO comprises one or more software libraries for inferencing, also referred to as an inference engine. In at least one embodiment, an inference engine is a C++ library, or any suitable programming language library. In at least one embodiment, an inference engine is utilized to infer input data. In at least one embodiment, an inference engine implements various classes to infer input data and generate one or more results. In at least one embodiment, an inference engine implements one or more API functions to process an intermediate representation, set input and/or output formats, and/or execute a model on one or more devices.

In at least one embodiment, OpenVINO provides various abilities for heterogeneous execution of one or more neural network models. In at least one embodiment, heterogeneous execution, or heterogeneous computing, refers to one or more computing processes and/or systems that utilize one or more types of processors and/or cores. In at least one embodiment, OpenVINO provides various software functions to execute a program on one or more devices. In at least one embodiment, OpenVINO provides various software functions to execute a program and/or portions of a program on different devices. In at least one embodiment, OpenVINO provides various software functions to, for example, run a first portion of code on a CPU and a second portion of code on a GPU and/or FPGA. In at least one embodiment, OpenVINO provides various software functions to execute one or more layers of a neural network on one or more devices (e.g., a first set of layers on a first device, such as a GPU, and a second set of layers on a second device, such as a CPU).

In at least one embodiment, OpenVINO includes various functionality similar to functionalities associated with a CUDA programming model, such as various neural network model operations associated with frameworks such as TensorFlow, PyTorch, and/or variations thereof. In at least one embodiment, one or more CUDA programming model operations are performed using OpenVINO. In at least one embodiment, various systems, methods, and/or techniques described herein are implemented using OpenVINO.

Other variations are within spirit of present disclosure. Thus, while disclosed techniques are susceptible to various modifications and alternative constructions, certain illustrated embodiments thereof are shown in drawings and have been described herein in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

### EXAMPLE CLAUSES

Implementation details of various embodiments of the present disclosure are described in the following numbered clauses
1. In some embodiments, a method comprises generating an unlabeled training data set based on random perturbation applied to biological complexes included in a labeled training data set, wherein: the labeled training data set includes a plurality of samples of biological complexes, and each respective sample of a biological complex is associated with a calculated binding affinity between molecules in the respective sample; training a predictive model to predict binding affinity of a first molecule to a second molecule based on a first loss associated with the labeled training data set and a second loss associated with the unlabeled training data set; and deploying the trained predictive model.
2. The method of clause 1, wherein the first molecule comprises a protein in a biological complex and the second molecule comprises a ligand in the biological complex.
3. The method of any of clauses 1 or 2, wherein generating the unlabeled training data set comprises generating a perturbed biological complex from a base biological complex in the labeled training data set based on applying a scaled amount of noise to one or more coordinates in the base biological complex.
4. The method of clause 3, wherein the perturbed biological complex comprises an unperturbed first molecule from the base biological complex and a perturbed version of a second molecule from the base biological complex.
5. The method of any of clauses 1 through 4, wherein the first loss associated with the labeled training data set comprises a mean-squared error loss between a predicted binding affinity between molecules in a biological complex in the labeled training data set and a calculated binding affinity for the biological complex in the labeled training data set.
6. The method of any of clauses 1 through 5, wherein the second loss associated with the unlabeled training data set comprises a denoising loss between a perturbed biological complex in the unlabeled training data set and a base biological complex in the labeled training data set.
7. The method of clause 6, wherein the denoising loss comprises a difference between a probability distribution associated with a predicted energy for the perturbed biological complex and a probability distribution associated with a predicted energy for the base biological complex from which the perturbed biological complex is sampled.
8. The method of any of clauses 1 through 7, wherein the predictive model is trained further based on a weighting factor applied to the second loss.
9. A processor-implemented method, comprising: predicting a binding affinity for a first molecule and a second molecule in a biological complex using a machine learning model, wherein the machine learning model comprises a model trained to generate the predicted binding affinity based on a first loss associated with a labeled training data set and a second loss associated with an unlabeled training data set generated from the labeled training data set; determining that the predicted binding affinity for the first molecule and the second molecule in the biological complex exceeds a threshold binding affinity; and based on the determining, performing one or more actions with respect to the first molecule and the second molecule.
10. The method of clause 9, wherein the first molecule comprises a protein in a biological complex and the second molecule comprises a ligand in the biological complex.
11. The method of any of clauses 9 or 10, wherein the one or more actions comprise synthesizing the second molecule in the biological complex as a treatment for a medical condition.
12. The method of any of clauses 9 through 11, wherein the first loss associated with the labeled training data set comprises a mean-squared error loss between a predicted binding affinity between molecules in a biological complex in the labeled training data set with a calculated binding affinity for the biological complex in the labeled training data set.
13. The method of any of clauses 9 through 12, wherein the second loss associated with the unlabeled training data set comprises a denoising loss between a perturbed biological complex in the unlabeled training data set and a base biological complex in the labeled training data set.
14. A processing system, comprising: at least one memory having executable instructions stored thereon; and one or more processors configured to execute the operations of any of clauses 1 through 13.
15. A processing system, comprising means for performing the operations of any of clauses 1 through 13.
16. A non-transitory computer readable medium having executable instructions stored thereon which, when executed by one or more processors, performs the operations of any of clauses 1 through 13.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor-implemented method, comprising:
generating an unlabeled training data set based on random perturbation applied to biological complexes included in a labeled training data set, wherein:
the labeled training data set includes a plurality of samples of biological complexes, and
each respective sample of a biological complex is associated with a calculated binding affinity between molecules in the respective sample;
training a predictive model to predict binding affinity of a first molecule to a second molecule based on a first loss associated with the labeled training data set and a second loss associated with the unlabeled training data set; and
deploying the trained predictive model.

2. The method of claim 1, wherein the first molecule comprises a protein in a biological complex and the second molecule comprises a ligand in the biological complex.

3. The method of claim 1, wherein generating the unlabeled training data set comprises generating a perturbed biological complex from a base biological complex in the labeled training data set based on applying a scaled amount of noise to one or more coordinates in the base biological complex.

4. The method of claim 3, wherein the perturbed biological complex comprises an unperturbed first molecule from the base biological complex and a perturbed version of a second molecule from the base biological complex.

5. The method of claim 1, wherein the first loss associated with the labeled training data set comprises a mean-squared error loss between a predicted binding affinity between molecules in a biological complex in the labeled training data set and a calculated binding affinity for the biological complex in the labeled training data set.

6. The method of claim 1, wherein the second loss associated with the unlabeled training data set comprises a denoising loss between a perturbed biological complex in the unlabeled training data set and a base biological complex in the labeled training data set.

7. The method of claim 6, wherein the denoising loss comprises a difference between a probability distribution associated with a predicted energy for the perturbed biological complex and a probability distribution associated with a predicted energy for the base biological complex from which the perturbed biological complex is sampled.

8. The method of claim 1, wherein the predictive model is trained further based on a weighting factor applied to the second loss.

9. A processor-implemented method, comprising:
predicting a binding affinity for a first molecule and a second molecule in a biological complex using a machine learning model, wherein the machine learning model comprises a model trained to generate the predicted binding affinity based on a first loss associated with a labeled training data set and a second loss associated with an unlabeled training data set generated from the labeled training data set;
determining that the predicted binding affinity for the first molecule and the second molecule in the biological complex exceeds a threshold binding affinity; and
based on the determining, performing one or more actions with respect to the first molecule and the second molecule.

10. The method of claim 9, wherein the first molecule comprises a protein in a biological complex and the second molecule comprises a ligand in the biological complex.

11. The method of claim 9, wherein the one or more actions comprise synthesizing the second molecule in the biological complex as a treatment for a medical condition.

12. The method of claim 9, wherein the first loss associated with the labeled training data set comprises a mean-squared error loss between a predicted binding affinity between molecules in a biological complex in the labeled training data set and a calculated binding affinity for the biological complex in the labeled training data set.

13. The method of claim 9, wherein the second loss associated with the unlabeled training data set comprises a denoising loss between a perturbed biological complex in the unlabeled training data set and a base biological complex in the labeled training data set.

14. A processing system, comprising:
at least one memory having executable instructions stored thereon; and
one or more processors configured to execute the executable instructions to cause the processing system to:
generate an unlabeled training data set based on random perturbation applied to biological complexes included in a labeled training data set, wherein:
the labeled training data set includes a plurality of samples of biological complexes, and
each respective sample of a biological complex is associated with a calculated binding affinity between molecules in the respective sample;
train a predictive model to predict binding affinity of a first molecule to a second molecule based on a first loss associated with the labeled training data set and a second loss associated with the unlabeled training data set; and
deploy the trained predictive model.

15. The processing system of claim 14, wherein to generate the unlabeled training data set, the one or more processors are configured to cause the processing system to generate a perturbed biological complex from a base biological complex in the labeled training data set based on applying a scaled amount of noise to one or more coordinates in the base biological complex.

16. The processing system of claim 15, wherein the perturbed biological complex comprises an unperturbed first molecule from the base biological complex and a perturbed version of a second molecule from the base biological complex.

17. The processing system of claim 14, wherein the first loss associated with the labeled training data set comprises a mean-squared error loss between a predicted binding affinity between molecules in a biological complex in the labeled training data set and a calculated binding affinity for the biological complex in the labeled training data set.

18. The processing system of claim 14, wherein the second loss associated with the unlabeled training data set comprises a denoising loss between a perturbed biological complex in the unlabeled training data set and a base biological complex in the labeled training data set.

19. The processing system of claim 18, wherein the denoising loss comprises a difference between a probability distribution associated with a predicted energy for the perturbed biological complex and a probability distribution associated with a predicted energy for the base biological complex from which the perturbed biological complex is sampled.

20. The processing system of claim 14, wherein the predictive model is trained further based on a weighting factor applied to the second loss.
